(19) United States
(12) Patent Application Publication
(10) Pub. No.: US 2005/0177629 A1
(43) Pub. Date: Aug. 11, 2005

(54) System and a method for communication network configuration planning by predicting evolution

(75) Inventors: Stephane Betge-Brezetz, Paris (FR); Olivier Martinot, Draveil (FR); Emmanuel Marilly, Antony (FR); Gerard Delegue, Cachan (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/665,508

(22) Filed: Sep. 22, 2003

(30) Foreign Application Priority Data
Sep. 23, 2002 (FR) 02 11 723

(51) Int. Cl. G06F 15/173

(52) U.S. Cl. 709/223

(57) ABSTRACT

A system (1) dedicated to processing configuration data of a communication network includes first calculation means (3) adapted to determine a network usage predictive state from first data representative of the usage of resources and/or services within said network and second calculation means (4) adapted to determine a network evolution planning proposal from the usage predictive state and second data representative of plant (Ri) of the network.

The field of the invention is that of communication networks, and more particularly that of communication network configuration planning.

The complexity of networks never ceases to increase because of the continuous integration of new services into networks and the continuous evolution of the plant that constitutes the networks, with the result that it becomes more and more difficult to predict their evolution in terms of services and traffic. Moreover, because of service level agreements (SLA) between network operators and their customers, predicting network evolution is becoming more and more important.

In the present context, the expression “predicting evolution” (or planning) refers to determining when and where it is necessary to integrate new plant (for example a router or a new card) or to increase the traffic capacity of a link, for example.

Prediction accuracy is all the more important in that precocious prediction constitutes an “oversizing” approach that is highly likely to be more costly than prediction at the proper time, while belated prediction runs the risk of violating service level agreements and consequently of causing customer dissatisfaction, possibly accompanied by payment of compensation, and even the loss of customers.

Two solutions have been proposed for predicting evolution. The first consists in defining link bandwidth usage thresholds and/or router congestion indication thresholds so that in the event of violation of said thresholds the network manager is advised that the network needs to evolve. The second solution consists in carrying out market research to estimate how customer requirements are evolving and to deduce how the network should evolve.

The above solutions are based on a small number of parameters and therefore do not provide a sufficiently precise evaluation of network evolution. In the case of the first solution, information is obtained on the source and the location of the future problem, but no information is provided as to how said problem will evolve, with the result that it is not possible to estimate the magnitude of the network evolution required.

For example, if the bandwidth threshold of a link is reached, there is a tendency to increase the capacity of the link systematically by a fixed percentage, regardless of what is really required. In the case of the second solution, the general trend of service usage evolution is known, but the extent to which this evolution risks disturbing the network is not known, and even less so the location(s) of future disturbances.

What is more, most prior art solutions propose network planning as a function of the evolution of network parameters, but without taking account of service usage and/or subscription evolution.

Thus an object of the invention is to remedy some or all of the problems previously cited.

To this end it proposes a system for processing configuration data of a communication network, including first calculation means capable of determining a network usage predictive state from first data representative of the usage of resources and/or services within said network and second calculation means capable of determining a network evolution planning proposal from the usage predictive state and second data representative of plant of the network.

In the present context, “first data” means network performance data such as current and old data on resource and/or service usage, for example. Moreover, in the present context “planning proposal” means a proposal for modification (or evolution) of the network, specifying in particular action to be taken on network plant and dates for the work to be carried out.

According to another feature of the invention, the first calculation means are preferably adapted to determine the network usage predictive state from complementary third data representative of user requirement prediction information, for example future types of SLA that might be entered into by the network operator and its current and/or future customers, and the predicted evolution of service subscriptions.

In this way, the system can determine a planning proposal on the basis not only of information (or parameters) accessible in the network but also of predicted customer requirements in terms of resources and/or services, obtained by means of market research, for example.

The first calculation means advantageously determine service level agreement usage profiles from the first data and the service level agreements (preferably a profile for each service level agreement), for example using a trend evolution analysis technique. In this case, it is preferable for the first calculation means to determine a service level agreement usage predictive profile constituting the network usage predictive state from service level agreement usage profiles and third data (where available).

Moreover, it is particularly advantageous for the second calculation means to include, firstly, traffic engineering means capable of determining an optimum configuration of the network from second data describing the network plant and a usage predictive state and, secondly, predictive state validation means supplying the traffic engineering means with the predictive state delivered by the first calculation means and capable, on receiving an optimum configuration associated with the predictive state, of determining whether the network can support the optimum configuration or not, and then, if it cannot, determining the network plant liable to be disturbed by the evolution of the network corresponding to the predictive state. In this case, the second calculation means can also include planning determination means connected to a planning database (organized in the form of rules, for example), adapted to determine the planning proposal from the designation of the disturbed plant and planning data from the database.

In the presence of such planning determination means, applying one or more planning proposal validation loops can be envisaged. To this end, the traffic engineering means are fed with the planning proposal and determine a new optimum configuration corresponding to the proposal and defining a “new” network. The validation means are thus used to verify if the new network, as defined by the planning proposal, can support the new optimum configuration or not; if it can, they send the planning determination means authorization to deliver the planning proposal that they have previously determined; if it cannot, they determine the network plant liable to be disturbed by the planning proposal so that the planning determination means can determine a new planning proposal that may be the subject of further validation.

Moreover, the processing system can include a graphical user interface adapted, firstly, to enable an operator to define the third data and/or to monitor validation of the planning proposals and, secondly, to display each planning proposal and/or each usage predictive state.

The invention also provides a communication network management system (NMS), for example an NMS server, equipped with a processing system of the type defined hereinabove.

The invention further provides a method of processing communication network configuration data, the method consisting in determining, firstly, a network usage predictive state from first data representative of the usage of resources and/or services within the network and, secondly, a network evolution planning proposal from the usage predictive state and second data representative of the network plant.

The method according to the invention can have numerous complementary features, and in particular, either separately or in combination:
the network usage predictive state can be determined from complementary third data representative of user requirement prediction information,
service level agreement usage profiles can be determined from the first data and service level agreements, preferably a profile for each service level agreement,
a service level agreement usage predictive profile constituting the network usage predictive state can be determined from service level agreement usage profiles,
the service level agreement usage predictive profile can be determined from third data and service level agreement usage profiles,
the service level agreement usage profiles can be determined by means of a trend evolution analysis,
an optimum configuration of the network can be determined from second data describing the plant of the network and an optimum configuration associated with said predictive state can be determined, after which it is determined if the network can support said optimum configuration or not and then, if it cannot, the network plant liable to be disturbed by the evolution of the network corresponding to the predictive state is determined,
the planning proposal can be determined from the designation of the disturbed plant and planning data stored in a database,
a planning proposal minimizing the costs of network evolution can be delivered,
before delivering the planning proposal, a new optimum configuration corresponding to it can be determined and, on receiving a new optimum configuration associated with the planning proposal, it can be determined if the new network, as defined by the planning proposal, can support the new optimum configuration or not and then, if it can, the planning proposal can be delivered and, if it cannot, the network plant liable to be disturbed by the planning proposal can be determined and a new planning proposal can be determined from the disturbed plant.

The invention can be used in any type of private or public communication network and in particular in Internet/IP, MPLS/GMPLS, ATM and Frame Relay networks.

Other features and advantages of the invention will become apparent on reading the following detailed description and examining the appended drawings, in which:

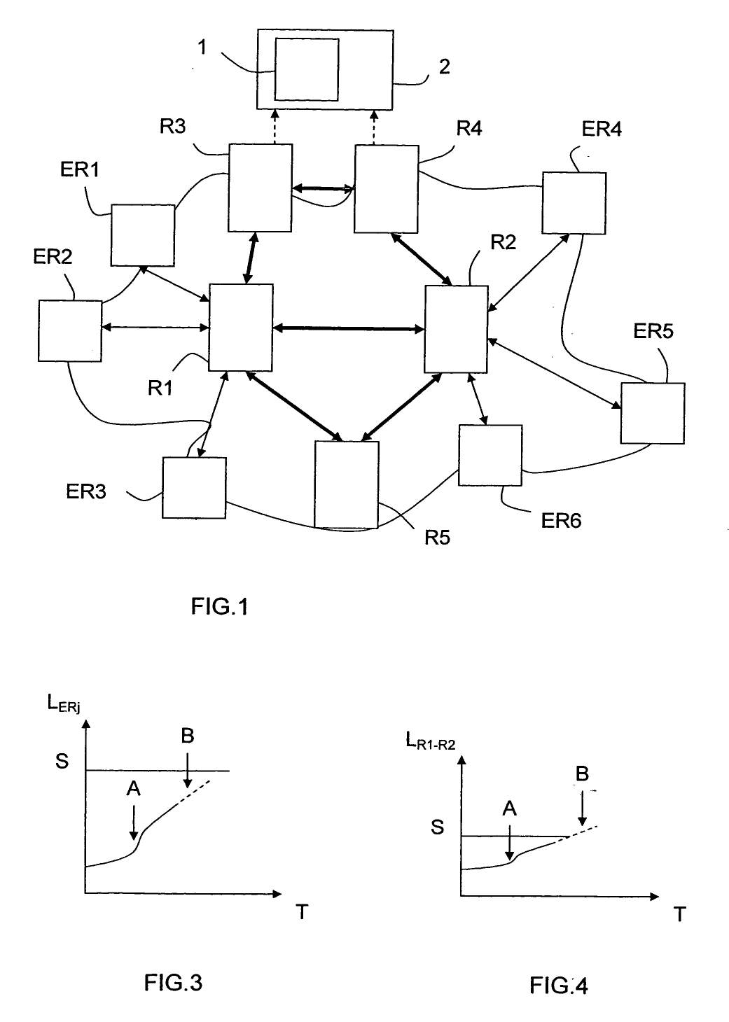

FIG. 1 shows diagrammatically a portion of a communication network equipped with a processing system according to the invention installed in a network management system server,

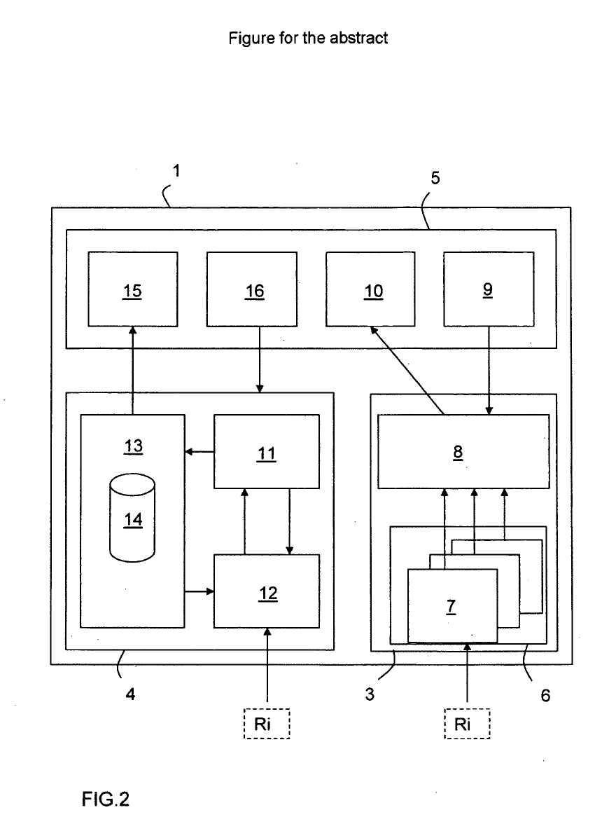

FIG. 2 shows diagrammatically one embodiment of a processing device according to the invention,

FIG. 3 is a diagram showing one example of the edge router load (L_{ERj}) of the network as a function of time (T), and

FIG. 4 is a diagram showing one example of the load (L_{R1-R2}) of a link between two core routers of the network as a function of time (T).

The appended drawings can constitute part of the description of the invention as well as, if necessary, contributing to the definition of the invention.

The processing system 1 according to the invention is intended to be installed at the core of a communication network of the type shown in FIG. 1, for example in a network management system (NMS) server of the network 2, so as to have access to network performance measurements, and in particular measurements of the usage of its resources and services.

By way of nonlimiting example, it is considered hereinafter that the network is an autonomous system (AS) of the Internet, which is a public network in which data is exchanged in accordance with the Internet Protocol (IP). However, it could be an Intranet private network or a plurality of interconnected public and/or private networks. Moreover, it is considered hereinafter that the customers of the network are linked to the operator by service level agreements (SLA) with technical portions defined by service level specifications (SLS).

The network shown in FIG. 1 by way of nonlimiting example includes a plurality of core routers Ri (here i=1 to 5) connected to each other by links shown by thick lines and edge routers ERj (here j=1 to 6) each connected, firstly, to one of the core routers Ri by a link shown in thin line and, secondly, to terminals and/or servers that are not shown.

As previously indicated, the above type of network generally includes a network management system server 2 connected to at least one of the core routers Ri and continuously supplied with data representative of network performance measurements, in order to deliver information on the operation of the network to the network manager, via a graphical user interface.

This information on its operation thus enables the network manager (or operator) to manage the network in real time. However, it does not directly allow prediction of the modifications that must be made to the network because of an increase in traffic and/or in the services offered, and more generally as a function of the future requirements of existing and future customers.

The invention therefore proposes a network configuration data processing system 1 adapted to generate, for the attention of the network manager, network modification proposals (or planning proposals) for predicting future requirements at the most appropriate time.

FIG. 2 shows one embodiment of a processing system 1 of the above kind. It includes firstly a first calculation module 3 adopted to determine a network usage predictive state from first data representative, firstly, of network resource usage measurements and, secondly, of measurements of service usage within the network. These measurements are preferably not only the latest ones obtained but also those obtained in the post (in a chosen time interval).

The processing system 1 also includes a second calculation module 4 adapted to generate network evolution planning proposals from the usage predictive state supplied by the first calculation module 3 and second data representative of the network plant. The second data preferably defines the topology of the network and the characteristics of the plant that constitutes it, in other words gives details of the resources offered by the network.

Moreover, the processing system 1 preferably includes a graphical user interface (GUI) 5, firstly for displaying the planning proposals generated by the second calculation module 3, and where applicable the predictive state determined by the first calculation module 4, on a screen, for example that of the network management system server 2, and secondly to enable the network manager to monitor the operation of the processing system 1.

In a preferred embodiment, the first calculation module 3 includes firstly an extraction module 6 capable of generating usage profiles of the service level agreements 7 from first data supplied in particular by the core routers Ri of the network and service level agreements between the network operator and its customers. The extraction module 6 preferably generates a usage profile for each SLA. Furthermore, the first data representing a record of network performance measurements, the extraction module 6 preferably generates usage profiles of the service level agreements 7 by extrapolation, using a trend evolution analysis technique. The extraction module 6 also delivers predictive or nonpredictive alarms, if an event occurs or risks occurring, based on analyzing the measurements and the measurement records.

Once the extraction module 6 has generated its usage profiles of the service level agreements 7, it communicates them to an aggregation module 8 of the first calculation module 3. This module determines the network usage predictive state from the usage profiles of the service level agreements 7 in particular, and preferably also from third data representative of information predicting user requirements.

For example, the third data consists of the future types of service level agreements likely to be entered into by the network operator and its current and/or future customers, and the predicted evolution of service subscriptions. It is derived by the operator from the results of market research and transmitted to the aggregation module 8, for example via a transmission module 9 of the graphical user interface 5.

The predictive state delivered by the aggregation module 8 is preferably a service level agreement usage predictive profile obtained by aggregating all service level agreement usage profiles, extrapolated from the first data received from the network, and then taking into account third data representative of future requirements. In fact, as previously indicated, the service level agreements consist of one or more service level specifications that define all technical parameters of the service (and the thresholds to be guaranteed). Each of these parameters is generally a real number whose value is estimated as a function of time, so that the record of a parameter generally takes the form of a curve. This applies in particular to the bandwidth, as shown in FIGS. 3 and 4. Consequently, aggregation is based on adding different curves associated with each parameter, for example a curve of the measurements (or extrapolation) and a curve obtained from the market research results. Weighting coefficients can be introduced, for example to give greater weight to some predictions, considered to be more reliable, or to some services, or to predictions rather than to market research curves.

Thus the system can determine a (re)planning proposal that is particularly accurate since it takes into account, firstly, the information (or parameters) representative of the network performance record and, secondly, predicted customer requirements in terms of resources and/or services.

Each predictive state produced by the aggregation module 8 of the first calculation module 3 is preferably transmitted to a first display module 10 of the graphical user interface 5 so that the network manager can analyze it and where applicable reject it if he does not wish it to be taken into account.

Also in a preferred embodiment, the second calculation module 4 includes firstly a validation module 11 responsible in particular for validating the predictive states delivered by the first calculation module 3 (here in the form of SLA usage predictive profiles). A predictive state is preferably validated in collaboration with a traffic engineering module 12 of the second calculation module 4, such as the ALCATEL 5620 TSOM in the case of MPLS networks.

First of all, the validation module 11 sends the traffic engineering module 12 the predictive state received, for it to determine an optimum configuration of the network from the predictive state and from second data representative of the actual configuration (layout) of the existing network. In fact, this determines the best possible usage of the resources of the existing network, taking account of the predictive state generated. Once the traffic engineering module 12 has determined the optimum configuration, it communicates it to the validation module 11 which verifies if the resources offered by the network plant (routers, switches, interfaces, physical links, logical links such as paths, connections, etc.) can support said optimum configuration. The description of these resources of the network (known as “model information”) is preferably shared by the components of the second calculation module 4.

If this is the case, this means that the existing network can support the future requirements. Consequently, it is not necessary to generate a network (re)planning proposal. The network manager is preferably advised of this via the graphical user interface 5.

On the other hand, if the existing network cannot support the future requirements, the validation module 11 determines which network plant is likely to be disturbed by the network evolution corresponding to the predictive state. Here, plant that is “likely to be disturbed” means plant that is inadequate for future requirements in terms of resources and/or services. For example, in the case of a second calculation module 4 such as the ALCATEL 5620 TSOM, an attempt is made to distribute the traffic load over all of the network resources. If the load is greater than the transport capacity of the network, some resources are overloaded, as in the case of “overbooking”. This solution works fairly well if not ail the customers using network resources are using the network simultaneously. The second module 4 thus supplies some or all of the information on overbooking of network resources.

Then, once it has determined the plant that is liable to be disturbed, the validation module 11 supplies their designations to a planning module 13 of the second calculation module 4 responsible for producing proposals for evolution (modification) of the existing network. In fact, the planning module 13 determines a new configuration of the network, for example by proposing updating some routers and/or some interfaces to support the highest bit rates.

The planning module 13 is preferably connected to a planning database 14 containing data that is preferably in the form of rules drawn up by a planner. These rules can take into account the overbooking information delivered by the second calculation module 4.

The rules might include, for example: “If a link is used more than 90%, then the capacity of that link must be increased by the appropriate amount”, or: “If a router has an interface that is used more than 80%, then it must be replaced by a router of the class above”, or: “If an interface of a router is overbooked by more than 20% of its maximum load, then a 50% updating of that interface must be proposed”.

The process of generating the planning data (rules) is preferably such that the planning proposal minimizes the cost of modifying the existing network.

The planning module 13 therefore generates a proposal for planning (or modification) of the network based on the designation of the disturbed plant and planning data contained in the database 14.

The planning (modification) proposal describes each item of plant to be modified or replaced, its precise location, and the most favorable time to carry out the modifications.

At this stage, before submitting the planning (modification) proposal to the network manager, a proposal validation loop can be executed. To this end, the planning module 13 sends its planning proposal to the traffic engineering module 12 for the latter to determine a new optimum configuration of the modified network that is the subject matter of the proposal. In fact this determines the best possible use of the resources of the proposed network. Once the traffic engineering module 12 has determined the new optimum configuration, it communicates it to the validation module 11, which verifies if the resources offered by the plant of the modified network can support said new optimum configuration.

If so, this means that the planning proposal is valid. The validation module 11 then authorizes the planning module 13 to communicate its planning proposal to a second display module 15 of the graphical user interface 5 so that the network manager can analyze it.

On the other hand, if the modified network cannot support the new optimum configuration, the validation module 11 determines which network plant is liable to be disturbed by the optimum configuration determined by the traffic engineering module 12. It then supplies the designations of the network plant liable to be disturbed to the planning module 13 so that it can determine a new planning proposal, which is subject to validation, where applicable. In fact, the processing system 1 can be configured to execute validation loops until the validation module 11 decides that a planning proposal is valid, in other words that there is no risk of any plant of the modified network being disturbed. A limit on the maximum number of validation loops can be set.

The graphical user interface 5 preferably includes a control module 15 enabling the network manager to monitor the planning procedure and in particular the validation loop.

One example of generating a proposal for modification of the network shown in FIG. 1 is described next with reference to FIGS. 3 and 4.

In this example, the edge routers ERj all have a load profile L_{ERj} of the type shown in FIG. 3. To be more precise, this load profile L_{ERj} has a first portion A, shown in continuous line, representing the evolution of the traffic measured as a function of time, and a second portion B, shown in dashed line, representing the predicted evolution of traffic as a function of time.

Moreover, the connection between the core routers R1 and R2 has a load profile L_{R1-R2} of the type shown in FIG. 4. To be more precise, this load profile L_{R1-R2} has a first portion A, shown in continuous line, representing the evolution of the traffic measured as a function of time, and a second portion B, shown in dashed line, representing the predicted evolution of the traffic as a function of time.

In this example, the load evolution prediction B of the edge routers ERj is still relatively far away from the maximum load threshold S set by the rules of the planning database 14. On the other hand, the load evolution prediction B of the connection between the core routers R1 and R2 indicates that its future load will exceed the maximum threshold S set by the rules of the planning database 14.

The traffic engineering module 12 determines an optimum configuration corresponding to the predictions made, allowing for the existing network. The validation module 11 then verifies if the existing network can support that configuration. In this example, as indicated above, the overload cannot be resolved by redistributing traffic between R1 and R2 on other links, since they would then reach their limits. Consequently, the validation module 11 deduces that there is a risk of an overload occurring at the core routers R1 and R2 and their connection, within the time period concerned. It therefore sends the planning module 13 the designations of the core routers R1 and R2 and their connection, for it to produce a planning proposal likely to alleviate the overload.

For example, the planning module 13 proposes to replace the connection between R1 and R2 with a connection having a much greater capacity (10 Gigabits instead of 2.5 Gigabits). This solution is chosen when the planning database 14 includes a rule stipulating that the number of connections whose capacity must be increased must be minimized, for example.

The first calculation module 3 and the second calculation module 4 of the processing device 1 can take the form of electronic circuits, software (data processing) modules, or a combination of circuits and software.

The invention also provides a method of processing communication network configuration data.

The method can be used by the processing system 1 described hereinabove. The main and optional functions and subfunctions provided by the steps of the method being substantially identical to those provided by the means constituting the processing system 1, only the steps implementing the main functions of the method according to the invention are described briefly hereinafter.

The method consists in determining, firstly, a predictive state of usage of the network from first data representative of the usage of resources and/or services within the network and, secondly, a network evolution planning proposal based on the usage predictive state and second data representative of the network plant.

The network usage predictive state can preferably be determined from third data complementary to the first data and representative of information on user requirement predictions.

Thanks to the invention, the network manager can obtain a particularly accurate diagnosis and a network modification (planning) proposal defining each item of plant to be modified or replaced, its precise location, and the most favorable time to carry out the modifications, and all this at minimum cost.

Moreover, the invention allows the network manager to define better the terms of the service level agreements (SLA) that it has to enter into with its future customers, taking account of the existing network, and the terms of the service level agreements that it must enter into with its future customers after the network has been modified.

The invention is not limited to the embodiments of the processing method and system described hereinabove by way of example only, but encompasses all variants within the scope of the following claims that the person skilled in the art might envisage.

Thus there has been described an application of the invention to Internet/IP networks, but it can be used in any type of private or public communication network, and in particular in MPLS/GMPLS, ATM, and Frame Relay networks.

Furthermore, the invention can also be used in the service creation and service offer phase effected by the operator of the network. Instead of varying the configuration of the existing network, it is possible to vary the definitions of the service level agreements to optimize the definitions of the service level specifications that can be supported by the existing network.

1. A system (1) for processing configuration data of a communication network, characterized in that it includes first calculation means (3) adapted to determine a network usage predictive state from first data representative of the usage of resources and/or services within said network and second calculation means (4) adapted to determine a network evolution planning proposal from said usage predictive state and second data representative of plant (Ri, ERj) of said network and said first calculation means (3) are adapted to determine usage profiles of service level agreements (7) between the operator of the network and customers from said first data and from said service level agreements.

2. A system according to claim 1, characterized in that said first calculation means (3) are adapted to determine said network usage predictive state from complementary third data representative of user requirement prediction information.

3. A system according to claim 1, characterized in that said first calculation means (3) are adapted to determine a service level agreement usage profile (7) for each service level agreement.

4. A system according to claim 1, characterized in that said first calculation means (3) are adapted to determine a service level agreement usage predictive profile constituting said network usage predictive state from said service level agreement usage profiles (7).

5. A system according to claim 1, wherein the said first calculation means (3) are adapted to determine a service level agreement usage predictive profile constituting said network usage predictive state from said service level agreement usage profiles (7); and wherein said service level agreement usage predictive profile from said third data and said service level agreement usage profiles.

6. A system according to claim 1, characterized in that said first data is chosen in a group comprising the current usage of resources and/or services of the network and at least a portion of the record of usage of the resources and/or services of said network.

7. A system according to claim 5, characterized in that said first calculation means (3) are adapted to determine said service level agreement usage profiles (7) by means of a trend evolution analysis.

8. A system according to claim 1, characterized in that said third data is chosen in a group comprising the future types of service level agreements and the future evolution of service subscriptions.

9. A system according to claim 1, characterized in that said second calculation means (4) include traffic engineering means (12) adapted to determine an optimum configuration of the network from said second data describing the plant (Ri, ERj) of said network and a usage predictive state and predictive state validation means (11) adapted i) to supply said traffic engineering means (12) with said predictive state delivered by said first calculation means (3) and ii) on receiving an optimum configuration associated with said predictive state to determine whether said network can support said optimum configuration or not and then, if it cannot, to determine the network plant liable to be disturbed by the evolution of the network corresponding to said predictive state.

10. A system according to claim 9, characterized in that said second calculation means (4) include planning determination means (13) connected to a planning database (14) and adapted to determine said planning proposal from the designation of the disturbed plant and said planning data from said database.

11. A system according to claim 10, characterized in that said planning determination means (13) are adapted to deliver a planning proposal minimizing the costs of network evolution.

12. A system according to claim 10, characterized in that at least some of said planning data takes the form of planning rules.

13. A system according to claim 10, characterized in that said planning determination means (13) are adapted, before delivering said planning proposal, to supply said traffic engineering means (12) so that they determine a new optimum configuration corresponding to said network evolution planning proposal and said validation means (11) are adapted, on receiving a new optimum configuration associated with said planning proposal, to determine if said network, as defined by said planning proposal, can support said new optimum configuration or not and then, if it can, to send to said planning determination means (13) an authorization to deliver said planning proposal and, if it cannot, to determine the network plant liable to be disturbed by said planning proposal and to send to said planning determination means (13) the designation of said disturbed plant for them to determine a new planning proposal.

14. A system according to claim 1, characterized in that it includes a graphical user interface (5) adapted to enable the definition of said third data by an operator and the display of each planning proposal.

15. A system according to claim 13, characterized in that it includes a graphical user interface (5) adapted to enable the definition of said third data by an operator and the display of each planning proposal, wherein said graphic user interface (5) is adapted to enable an operator to monitor the validation of planning proposals.

16. A system (2) for managing a communication network, characterized in that it includes a processing system (1) according to claim 1.

17. A method of processing communication network configuration data, characterized in that it consists in determining i) a network usage predictive state from first data representative of the usage of resources and/or services within said network and ii) a network evolution planning proposal from said usage predictive state and second data representative of plant (Ri, ERj) of said network, and in that usage profiles of service level agreements (7) between the operator of the network and customers are determined from said first data and said service level agreements.

18. A method according to claim 17, characterized in that said network usage predictive state is determined from complementary third data representative of user requirement prediction information.

19. Use of a method, a processing system (1), and a management system (2) according to claim 1 in networks chosen in a group comprising Internet (IP), MPLS/GMPLS, ATM and Frame Relay networks.
